(19) United States
(12) Patent Application Publication
(10) Pub. No.: US 2021/0370339 A1
(43) Pub. Date: Dec. 2, 2021

(54) UPRIGHT BATTERY POWERED FLOOR STAINING MACHINE

(71) Applicant: MAXWELL A SUTTON, HARTSELLE, AL (US)

(72) Inventor: MAXWELL A SUTTON, HARTSELLE, AL (US)

(21) Appl. No.: 16/888,025

(22) Filed: May 29, 2020

(51) Int. Cl. B05C 1/06; B05C 17/00

(52) U.S. Cl. CPC B05C 1/06; B05C 17/002

(57) ABSTRACT

An upright device for applying stain to wood floors wherein a user walks behind the device. The device may be battery powered eliminating the need for a cord. A means for holding a gallon of stain is included so that a user may operate the machine continuously while using an entire gallon of stain. Pumps control the movement of stain from the gallon container of stain into three rotary-motion applicator pads: a large round central applicator pad surrounded by two, smaller round applicator pads that may reversibly move about the outer circumference of the large, central applicator pad.

### CROSS-REFERENCE TO RELATED APPLICATIONS

This application does not claim priority to any patent application.

### DISCLOSURE REGARDING PRIOR DISCLOSURES BY THE INVENTOR OR A JOINT INVENTOR

The inventor has not disclosed this invention prior to the filing of this non provisional application.

### BACKGROUND OF THE INVENTION

### (1) Field of the Invention

This invention relates to upright rotary machines that are used to apply stain to wood floors during the finishing/refinishing process. Specifically, the device herein has an improved means for dispensing stain and an improved pad means for distributing the stain onto the wood floor.

### (2) Disclosure of the Prior Art

A number of upright rotary devices that dispense stain onto a floor are disclosed in the prior art. May et al. (U.S. Pat. No. 4,881,288) discloses an upright rotary machine that cleans a floor by rotating a cleaning or buffing pad against the floor at high speed. The device includes a means to control the rate of fluid dispensed while cleaning the floor and a vacuum source to draw cleaning fluid out of an attached reservoir and into the central region of the cleaning pad. This device includes a bottle of cleaning fluid reversibly coupled to a tubing line. An operator places his thumb over a thumb hole and holds it there to impart suction onto the contents of the bottle. This causes fluid to be sucked out of the bottle until the fluid level in the bottle drops enough to create an equalizing vacuum in the bottle. Flow from the bottle stops, but the suction will then lower the liquid level in an air supply vent allowing air to enter. When the fluid level is pulled down low enough an air bubble will enter the bottle, reducing the vacuum above the fluid level and allowing more fluid to be drawn out of the bottle and into the pad housing.

The device of May et al. is specifically designed for floor cleaning wherein a variable rate of application of cleaning solution to the floors is permissible. The device of Sutton herein is specifically designed for application of stain to floors. Any variation in the application rate of stain onto the surface of wood floors will create variation in the floor color. For example, if the rate of stain application increases, more stain will be applied, creating darker colored wood floors. If the rate of stain application decreases, then less stain will be applied and the color and/or tint intensity of the wood floor will decrease. This can create streaks, blotches, smears, and other discernible differences in floor color that detract from the appearance of the floor.

Gary Rudolph (US 2017/0245721 A1) discloses an upright rotary floor machine that delivers fluid to and from a bottom center of a floor-operation pad with a fluid-delivery hub comprising a pad formed to create a flow of fluid along the circumference of the pad and inward toward the center of the pad via three separate channels. The hub further comprises a fluid management metering system comprising a bag of fluid coupled to the upright handle of the device wherein the pressure forcing the fluid through the pad originates solely from the weight of the fluid in the bag of fluid and the flow rate of the fluid from the bag of fluid is controlled via meters controlled by the operator.

The device of Rudolph manipulates the dispensing of liquid via gravity from the weight of fluid in a suspended bag of fluid. When the bag of fluid is full, then gravity is great forcing fluid into the pad at a high rate. Upon use, fluid leaves the bag of fluid reducing the weight of fluid within the bag, reducing the force of gravity upon the bag, resulting in a diminished flow of fluid into the pad as a user dispenses fluid. The difference in flow of fluid into the pad creates a difference in stain color wherein a deeper stain color is obtained initially when the bag is full of fluid and a light stain color when the bag is approaching empty. A method of controlling the flow of stain so that the flow is consistent is needed.

Both May et al. and Rudolph utilize power cords to power the spinning of the dispenser pads. If a user steps on a power cord while staining a floor, then the point of cord contact with the virgin floor causes the grain of the wood at that point to close altering the absorption of stain, which causes streaks in the floor. A user stepping on a cord must re-sand the floor to reopen the grain of the wood. This problem effectively mandates that a person applying stain to a wood floor have a helper to hold the cord through out the staining process. A cordless device would alleviate this problem.

May et al. and Rudolph utilize a single, large, round pad to apply fluid to a floor. The large round pad is unable to effectively reach corners of a square room. When a user is applying stain to a floor a helper is necessary to apply stain in the corners so that the stain can be applied evenly in a single coat. A device is needed that reaches into corners so that a 2^{nd} helper is not needed when applying stain.

May et al. and Rudolph allow bags of fluid/stain to be coupled to the devices. Stain is not readily available for purchase in small bags. Additionally, if a user needs to refill a bag of stain, then the user has to stop the machine and replace the bag. Anytime a user applying stain stops the application (stops and starts), the rate of stain deposition onto the virgin wood floor changes causing a change in the stain intensity and may even streak the floor. A device that will accept an entire gallon of stain is needed.

Today, professionals typically apply floor stain as follows: dip rag or sponge into stain and apply stain to floor, going with the grain rather than against. Work from one side of the room to the other, frequently wringing out rag or sponge so coverage is even and stain doesn't pool on floor. After 5 or 10 minutes, the floor is vigorously wipe to remove excess stain. Then the stain is allowed to dry before application of polyurethane. This hand application method is time consuming, strains the back of the user, and is subject to variations of color absorption because of lack of uniform application. A device that mechanically applies stain is needed to alleviate these issues.

### BRIEF SUMMARY OF THE INVENTION

This device comprises an upright rotary machine that a user walks behind. It may be battery powered alleviating the need for a power cord. The battery provides power for the applicator pads and for movement of fluid onto the applicator pads. This device includes two small, round applicator pads proximate to a central, large applicator pad, which reduces stain work in the square corners of a room. Both small, round applicator pads move relative to the central, large applicator pad so that it will cover the corners more effectively. And, the device herein accepts an entire gallon of stain and includes a holder that a user inserts an opened can of stain into prior to using the machine.

### BRIEF DESCRIPTION OF THE DRAWINGS

The invention is described in detail below with reference to the appended drawings.

FIGS. 1 through 23 depict the Upright Battery Powered Floor Staining Machine. In the Figures:

FIG. 1 depicts an angled, front view of the device with a gallon of stain couple thereto.

FIG. 2 is an exploded view of FIG. 1.

FIG. 3 is a view of FIG. 1 wherein the two smaller stain pads are in the side position.

FIG. 4 illustrates the large stain pad assembly.

FIG. 5 depicts the motor and applicator pad mounting. An exploded view of FIG. 5 is depicted in FIG. 6.

A small applicator pad assembly is shown in FIG. 7, and an exploded view of a small applicator pad assembly is shown in FIG. 8.

A cage for storing a gallon of stain is illustrated in FIG. 9.

FIG. 10 depicts a small pad attachment bracket.

The wheel assembly is illustrated in FIG. 11.

The gallon of stain anchoring assembly and the gallon of stain lid assembly are shown in FIG. 12.

An exploded view of the gallon of stain lid assembly is shown in FIG. 13.

FIG. 14 depicts a handle assembly.

FIG. 15 illustrates a side view of the device with the applicator pads in the forward position, while FIG. 16 depicts an angled side view of the device with the small applicator pads in the forward position.

A illustration of the device with both small applicator pads in the side position is shown in FIG. 17.

FIG. 18 depicts a top view of the device, while FIG. 19 depicts a bottom view of the device.

FIG. 20 depicts a front, angled view of the handle assembly with advanced controls, and

FIG. 21 depicts an exploded view of FIG. 20.

FIG. 22 illustrates an embodiment battery placement on the applicator pad mounting and cage.

FIG. 23 depicts a top view of FIG. 22.

### DETAILED DESCRIPTION OF THE INVENTION

While this invention is susceptible of embodiment in many different forms, there are shown in the drawings and will herein be described in detail, several embodiments with the understanding that the present disclosure should be considered as an exemplification of the principles of the invention and is not intended to limit the invention to the embodiments so illustrated. Further, to the extent that any numerical values or other specifics of materials, etc., are provided herein, they are to be construed as exemplifications of the inventions herein, and the inventions are not to be considered as limited thereto.

The following description and drawings are illustrative and are not to be construed as limiting. Numerous specific details are described to provide a thorough understanding of the disclosure. However, in certain instances, well-known or conventional details are not described in order to avoid obscuring the description. References to one, or an embodiment in the present disclosure, can be, but not necessarily, references to the same embodiment; and, such references mean at least one of the embodiments.

Reference in this specification to “one embodiment’ or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments, but not other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same term can be said in more than one way.

Consequently, alternative language and synonyms may be used for any one or more of the terms discussed herein, or is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and in no way limits the scope and meaning of the disclosure or of any exemplified term. Likewise, the disclosure is not limited to various embodiments given in this specification.

Unless otherwise defined, all technical and scientific terms used herein have the same meaning as commonly understood by one of ordinary skill in the art to which this disclosure pertains. In the case of conflict, the present document, including definitions will control.

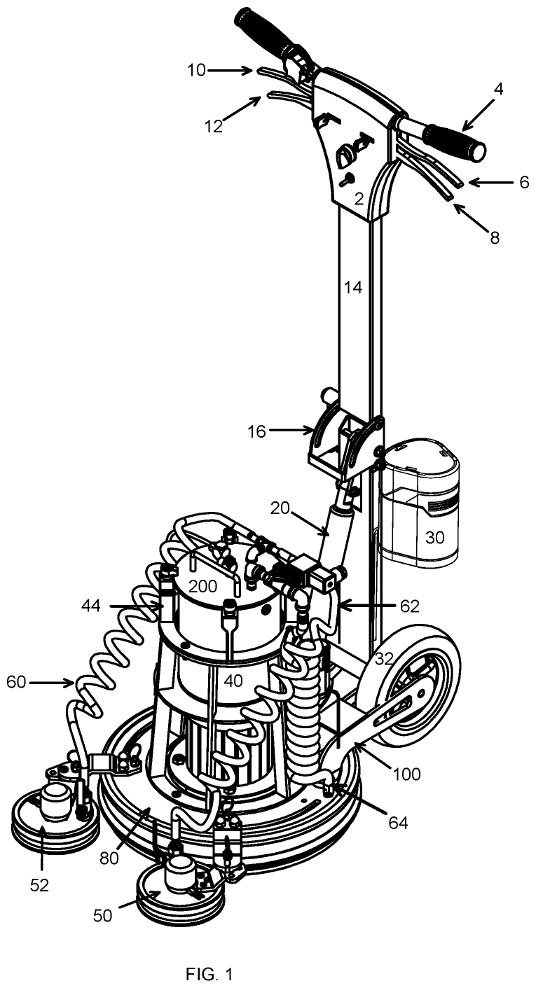

FIG. 1 depicts an angled front view of the device. Handles 4 stem from control panel 2. Handles 4 allow are a means for a user to grip the device, while control panel 4 may include a on/off means, etc. Lever 6 may allow a user to control the amount of stain released onto the large stain disk. Lever 10 may allow a user to control the rate of spin of the large stain disk, which is mounted onto large mounting disk 80. Lever 8 may allow a user to control the rate of spin of small left mounting disk 50 and the amount of stain released onto the small left stain disk. Lever 12 may control the rate of spin of small right mounting disk 52 and the amount of stain released onto the small right stain disk. Upright handle 14 couples control panel 2 to wheel base 100, wheel base 100 forms a base to couple wheels 32 to the device. Gas shock 20 couples tension control bracket 16 to wheel base 100. Gas shock 20 may be used to reduce the amount of motion transferred from the large stain disk and two smaller stain disks while staining a floor. This reduction in motion provides the user with greater comfort while using the device and greater control over the device. Gas shock 20 may be an air filled shock or other shock absorbing means. Battery pack 30 may be coupled to upright handle 14.

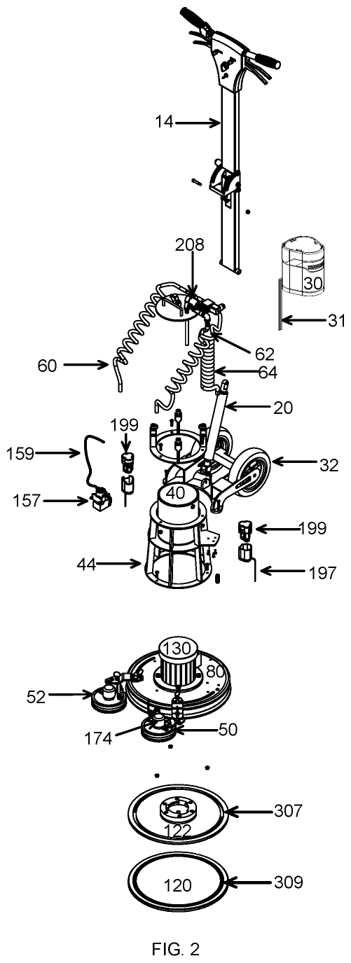

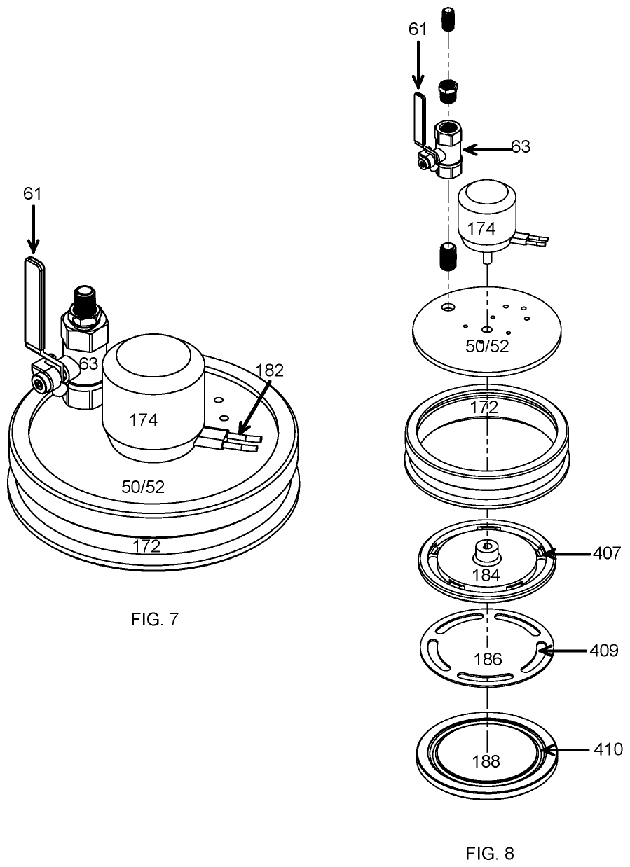

Stain can 40 is shown mounted within mounting cage 44, that is affixed to large mounting disk 80. Stain can 40 may contain a quart or gallon of liquid stain that is to be applied to flooring. Lid 200 reversibly couples to stain can 40 and provides the means for the transport of stain from the stain can to stain pads. Hose 62 provides stain from stain can 40 to the large stain pad 120 (shown in FIG. 2). Hose 60 provides stain from stain can 40 to small stain pad(s) 188 (shown in FIG. 7) that are coupled to small mounting disks 50 and 52.

FIG. 2 is an exploded view of FIG. 1. Tension control bracket 16 is coupled to upright handle 14. Battery pack 30 has been removed from handle 14. Electric cord 31 transfers power produced by battery pack 30 to the motor 130, which provides the means that causes large mounting disk 80 to rotate when stain is being applied to flooring. And, electric cord 31 transfers power produced by battery pack 30 to small motors 174, which cause small mounting disks 50 and 52 to rotate while stain is being applied to flooring. Shock 20 reduces the vibration experienced by the user.

Motor 130 is coupled to large mounting disk 80. Large stain hub 122 reversibly couples to large mounting disk 80. Large stain hub 122 provides a platform for large velcro pad 120, which reversibly couples to large stain hub 122. Large velcro pad 120 includes one or more areas of velcro that allow a user to quickly, easily, and reversibly attach large stain pad 400 (not shown). Large stain pad 400 may be composed of a carpet textile, such as polypropylene, nylon, polyester wool, cotton, cotton terry, or acrylic. The carpet textile should provide a smooth and streak-free finish with effortless application. Large stain hub 122 includes hub stain channel 307, which allows stain to move from hose 64 to large velcro pad stain channel 310. Large velcro pad 120 includes large velcro pad stain channel 309 that allows stain to flow through onto large stain pad 400.

Wheel base 100 secures large mounting disk 80. Wheels 32 allow the device to be moved about a floor. Stain can 40 is shown installed within mounting cage 44. Air pump 157 may be utilized to pump air into stain can 40 via air hose 159 while stain is being pumped out of stain can 40 to enable continuous, smooth flow of stain. Female “T” 208 provides stain from stain can 40 to hose 60 and hose 62. Hose 60 provides stain

to small right mounting disk 52, and hose 62 provides stain from stain can 40 to small left mounting disk 50. The device may include small battery 199 to provide power to the small left mounting disk 50 and the small right mounting disk 52. Small batter 199 may be contained within small battery receptacle 197. Small battery receptacle 197 may provide power to small motor 174 in order to power the rotation of the small left mounting disk 50 and the small right mounting disk 52.

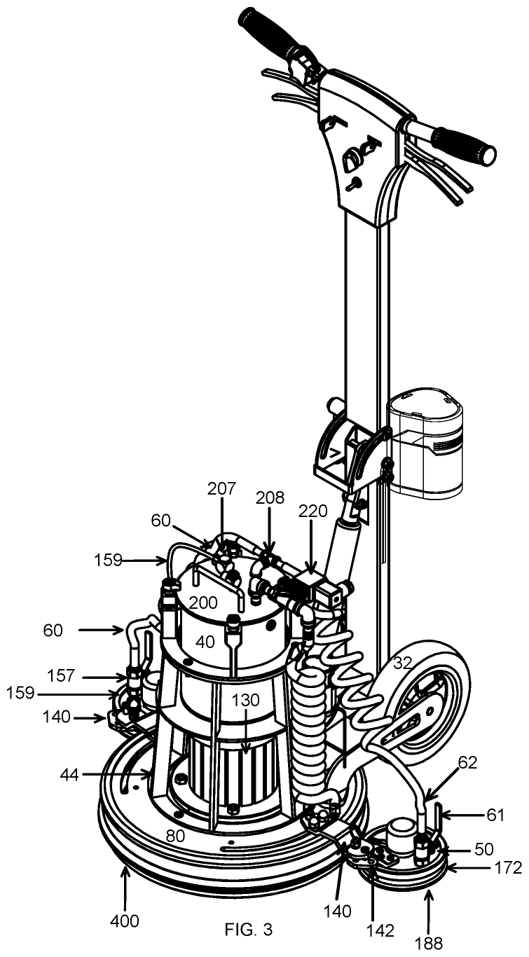

An angled side view of the device with the small motors in the rear position is depicted in FIG. 3. Small left motor 52 is shown in the rear position where is it located proximate to wheel 32. Small left motor 52 is secured to large mounting disk 80 via motor mounting bracket 140 and small disk mounting bracket 142. Small stain pad 188 is shown on the bottom surface of small left motor 52. Small stain rotor bumper 172 may be included to protect any wall surfaces from contact with small left mounting disk 52. Shutoff valve 61 allows a user to manually terminate all stain flow from hose 62.

Large stain pad 400 can be seen on the bottom surface of large mounting disk 80. Large mounting disk 80 secures mounting cage 44. Motor 130 is contained within mounting cage 44. Motor 130 provides enables the rotation of large stain pad 400. Stain can 40 is secured within mounting cage 44. Lid 200 has been placed onto the top of stain can 40. The following may be found coupled to lid 200: pressure release valve 207, which regulates pressure within stain can 40; female “T” 208 that splits a flow of stain from stain can 40 to hose 60 and hose 62, and powered solenoid valve 220 that regulates and controls the movement of stain out of stain can 40 and into hose 64. Pressure release valve 207 receives and regulates a flow of air traveling from air pump 157 via air hose 159.

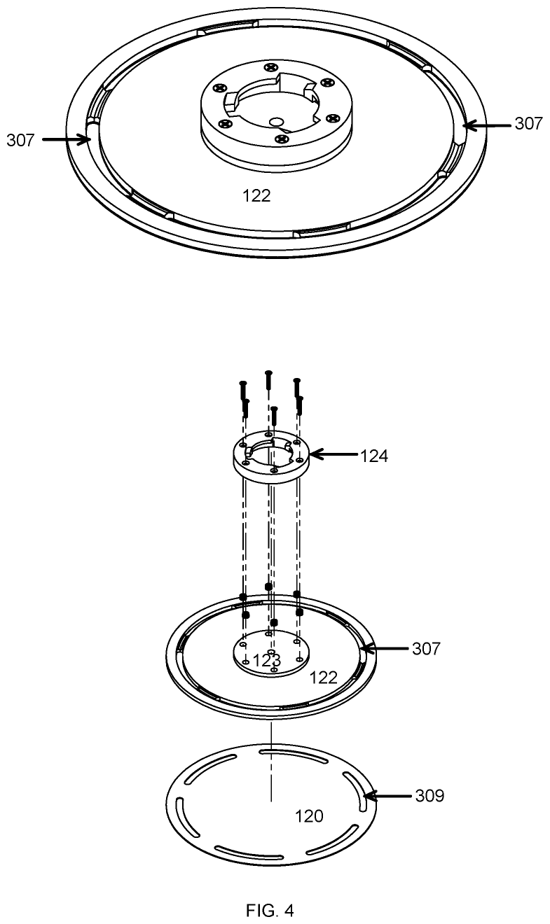

FIG. 4 depicts the large stain pad assembly that mounts or locks onto the bottom of large mounting disk 80. Large stain hub 122 may include at least one stain hub channel 307 that permits stain to travel from hose 64 through large stain hub 122 to large velcro pad 122. Hub disk 124 may be the means by which large stain hub 122 locks onto a 3 prong extension on the bottom, or underside, of large mounting disk 30. Large velcro pad 120 may include at least one large velcro pad stain channel 309, that provides stain from stain hub channel 307 to stain pad channel 310 (not shown), which delivers the stain to the floor being stained.

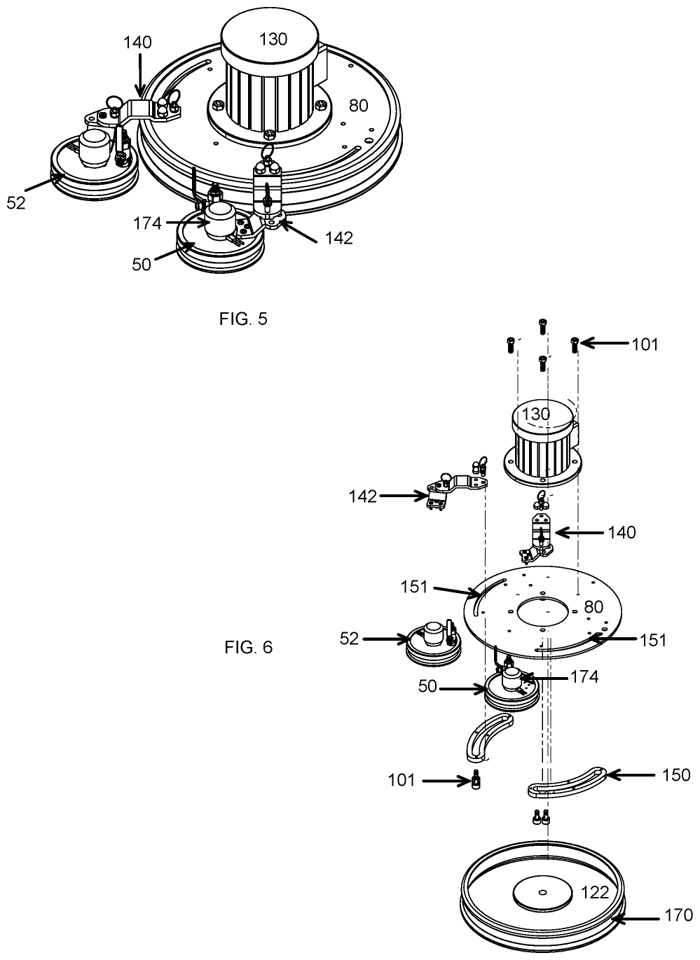

FIG. 5 illustrates the large motor and large applicator pad assembly, while FIG. 6 depicts an exploded view of FIG. 5. Motor 130 provides the mechanical force to cause rotational movement of large mounting disk 80. The amount of mechanical force provided by motor 130 is minimal because the device is merely applying stain to a previously prepared and finished floor. The minimal mechanical force requirements of motor 130 allow the device to be operated with DC power produced from a battery/battery pack instead of AC power provided by an electrical outlet. Small motor 174 provides the rotational movement of the small left mounting disk 50 that it is paired with, and rotational movement of the small right mounting disk 52 that it is paired with. Small left mounting disk 50 and small right mounting disk 52 are mounted onto large mounting disk 80 via motor mounting bracket 140 that attaches to the large mounting disk 80 and small disk mounting bracket 142 that attaches to the small left and right mounting disks 50 and 52. FIG. 5 depicts the small left and right mounting disks 50 and 52 in the front position.

The exploded view of FIG. 6 also depicts screws 101 securing the components onto large mounting disk 80. Large stain pad hub 122 is shown separated from large mounting disk 80. Large staining rotor bumper 170 is positioned along the outer perimeter of large mounting disk 80 to protect wall surfaces when a user presses the device against a wall. Large mounting disks 80 includes at least one cam roller slot 151 that allows the small left and right mounting disks 50 and 52 to move through cam roller guides 150 allowing the small left and right mounting disks 50 and 52 to move about large mounting disk 80, which allows the small left and right mounting disks 50 and 52 to move from the forward position to the rear position. The small left and right mounting disks 50 and 52 may be moved about the cam rollers by a user pushing the device along a wall causing said small left and right mounting disks 50 and 52 to freely rotate within cam roller slot 151. Instead, small motor 174 may provide the force that moves small left and right mounting disks 50 and 52 upon user command.

FIG. 7 depicts a side view of the small left and right mounting disks 50 and 52, while FIG. 8 illustrates an exploded view. Shutoff valve 61 allows a user to manually terminate the flow of stain into the small left and right mounting disks 50/52. Pressure gauge 63 regulates pressure within the shutoff valve maintaining a consistent, smooth flow of stain into the small left and right mounting disks 50/52. Small motor 174 receives power battery 30 and operating instructions from control panel 2 (both shown in FIG. 1) via wires 182. Small motor 174, pressure gauge 63, and small stain disk hub 184 are shown unmounted from small left and right mounting disks 50/52. Small motor 174 may be any motor that provides sufficient mechanical power to cause the small mounting disks to rotate. The mechanical power provides will be minimal because the small mounting disks are merely rotating about the finished surface of the flooring. The minimal mechanical force requirements of small motor 174 allow the device to be operated with DC power produced from a battery/battery pack instead of AC power provided by an electrical outlet.

Small staining rotor bumper 172 is mounted onto the perimeter of each small left and right mounting disks 50/52 to protect damage to wall surfaces from contact with the small left and right mounting disks 50/52. Small stain disk hub 184 may include small stain disk hub channel 407 that allows stain that has traveled to the small left and right mounting disks 50/52 to travel through small stain disk hub 184 to small velcro disk 186. Small velcro disk 186 allows small stain pad 188 to be reversibly coupled to small stain disk hub 184. Small velcro disk 186 includes small velcro disk channel 409 that allows stain received from small stain disk hub 184 to be transmitted to small stain pad channel 410. Stain received in small stain pad channel 410 is applied onto flooring to stain the flooring.

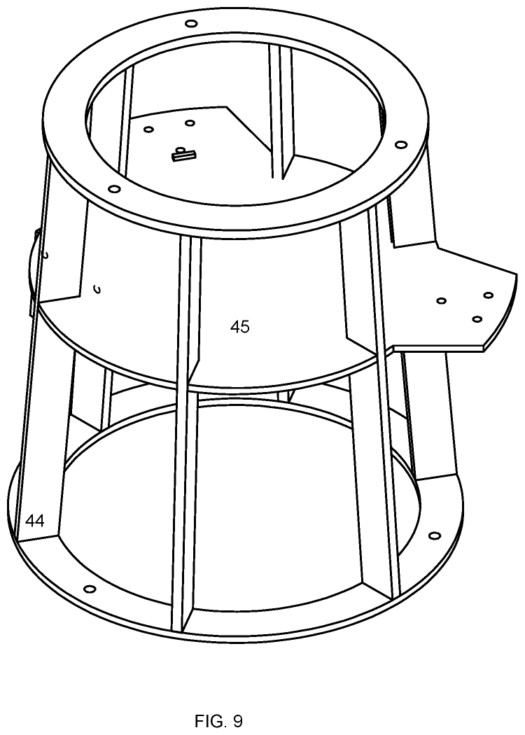

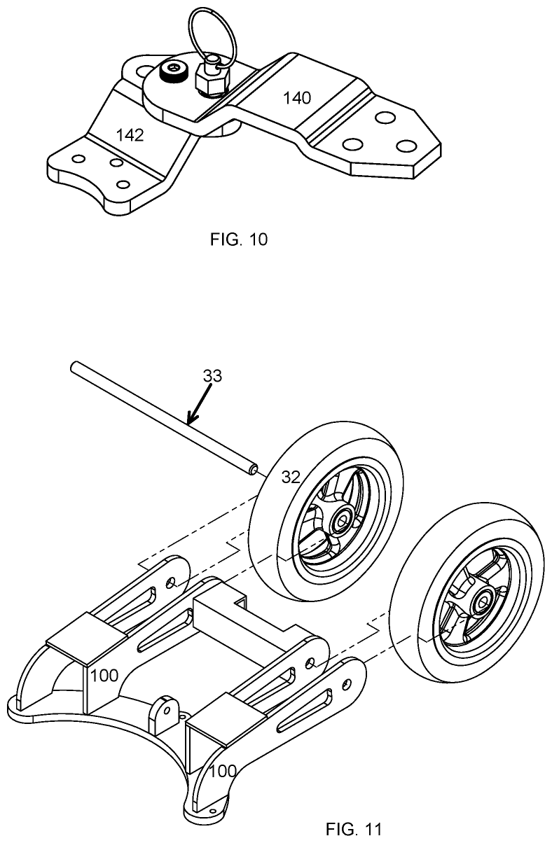

FIG. 9 depicts mounting cage 44 which is tightly secured onto large mounting disk 80. Motor 130 may be mounted below mounting shelf 45, while stain can 40 may be positioned on top of mounting shelf 45. Motor mounting bracket 140 and small disk mounting bracket 142 are shown in FIG. 10. Motor mounting bracket 140 is mounted onto large mounting disk 80. Wheel base 100 is shown in FIG. 11. Wheels 32 are shown separated from wheel base 100 and axle 33 has been removed from wheels 32.

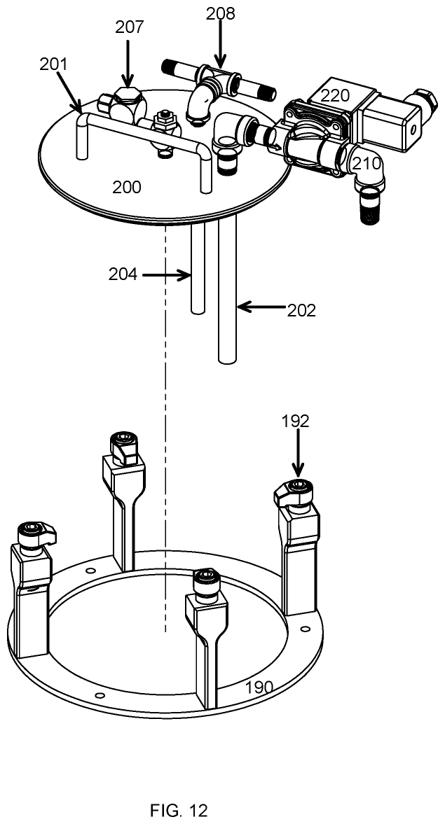

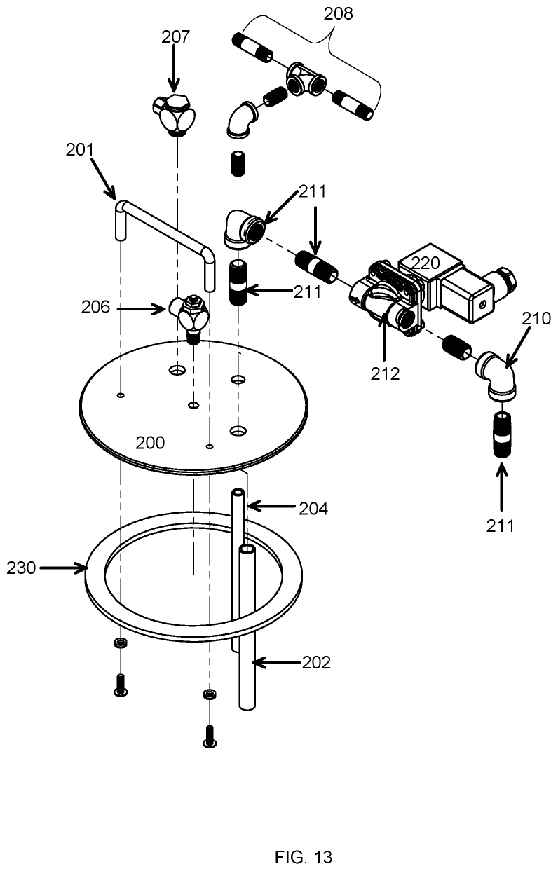

The clamping weldment stain can retainer 190 and the lid assembly are shown in FIG. 12, and an exploded view is shown in FIG. 13. The clamping weldment stain can retainer 190 is mounted on top of mounting cage 44. Stain can 40 fits within clamping weldment stain can retainer 190. Swivel L-hook clamp 192 swivel on top of stain can 40 securing stain can 40 into mounting cage 44. Lid assembly includes lid 200 that is positioned on top of stain can 40. Lid handle 201 is used by a user to grip the lid assembly to move the lid assembly relative to stain can 40. Pressure release valve 207 is mounted on top of lid 200. Small pipe 204 provides stain from stain can 40 to female “T” 208, where the stain is distributed to hose 60 and 62. Tube fitting 206 connects pressure release valve 207 to lid 200. Large pipe 202 provides stain from stain can 40 to hose 64 via 90° elbow 210. Powered solenoid valve 220 regulates flow of stain from large pipe 220 to 90° elbow 210. Manifold 212 directs and distributes airflow to support powered solenoid valve 220. Fittings 211 couple manifold 212 to lid 200. Seal 230 prevents airflow into and out of stain can 40.

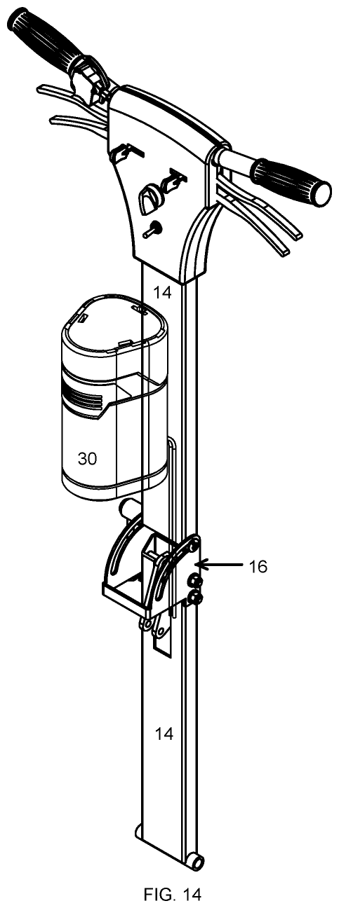

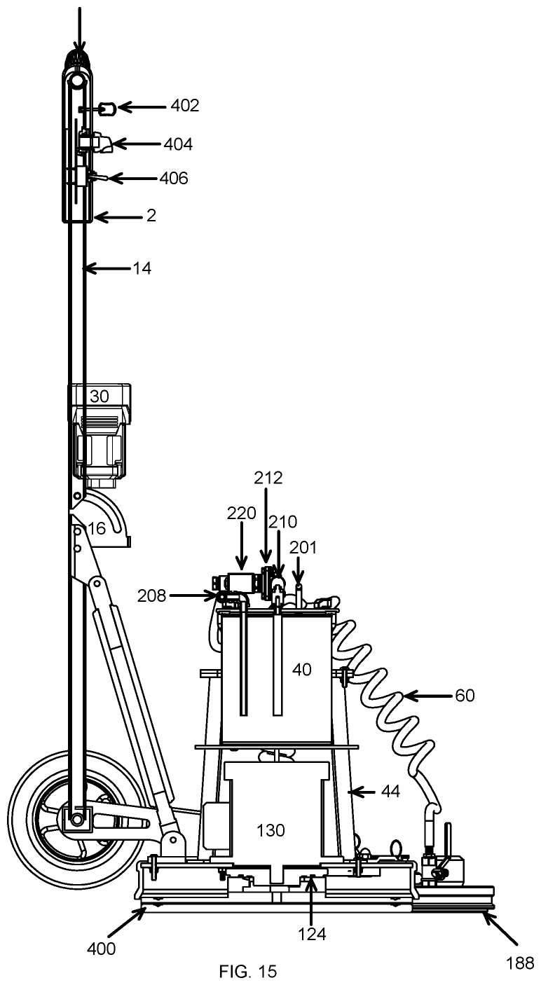

FIG. 14 illustrates battery 30 placed on the front of upright handle 14 above tension control bracket 16. Battery 30 may be place in any suitable position that does not interfere with operation of the device FIG. 15 shows a side view of the device wherein battery 30 is positioned in FIG. 14. Small disks on/off switch 402 may be positioned on control panel 2. Small disks on/off switch 402 allows a user to turn small left and right mounting disks 50/52 off and on as needed. Control panel 2 may also include solenoid flow adjustment 404 switch and air compressor on/off switch 406. Solenoid flow adjustment 404 controls the operation of powered solenoid valve 220. Air compressor on/off switch 406 controls the operation of air pump 157. Battery 30 is positioned above tension control bracket 16. Motor 130 is shown engaging disk hub 124. Large stain pad 400 and small stain pad 188 are in contact with the floor. Stain from stain can 40 travels through female “T” 208 to hose 60 and small stain pad 188. Stain from stain can 40 travels through 90° elbow 210 to large stain pad 400 while being controlled by powered solenoid valve 220 utilizing manifold 212. Lid handle 201 is shown.

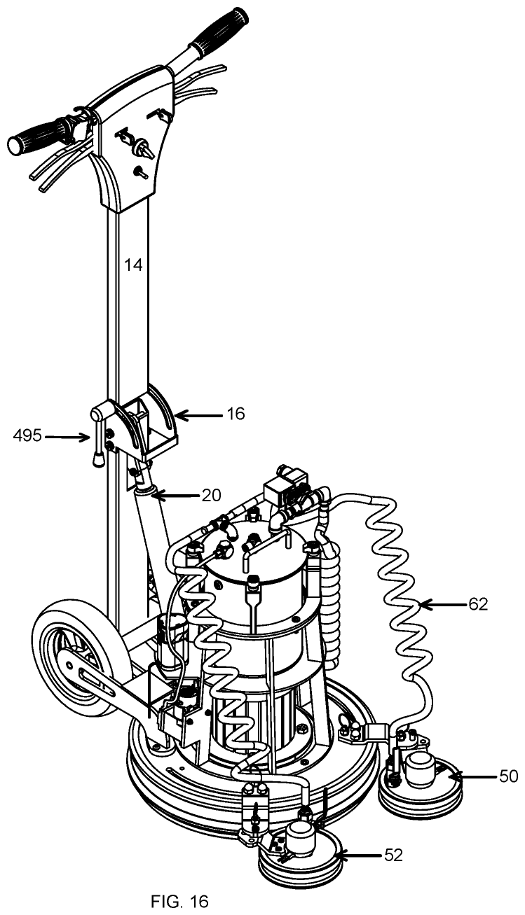

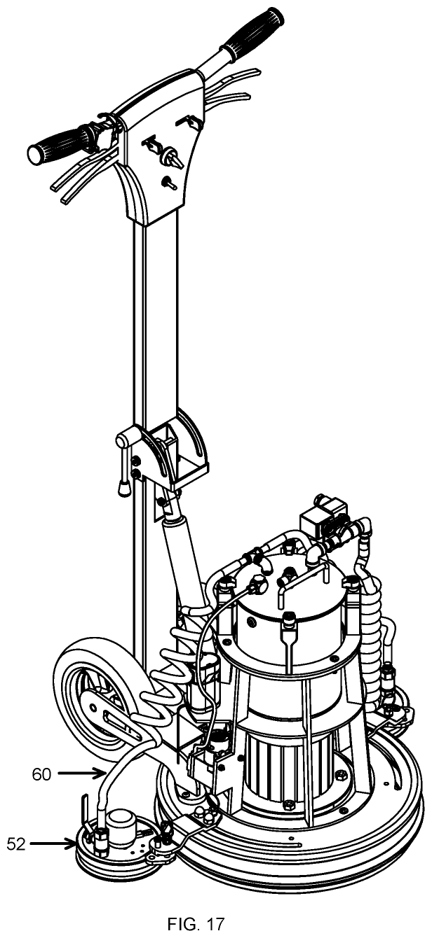

FIG. 16 illustrates optional tension release handle 495 which may be manipulated by a user to move upright handle 14 relative to tension control bracket 16, which causes movement of air within gas shock 20. Small left and right mounting disks 50/52 are shown in the forward position and hose 62 is visible. FIG. 17 illustrates the device wherein small left and right mounting disks 50/52 are in the rear position. Hose 60 is shown coupled to small right mounting disk 52.

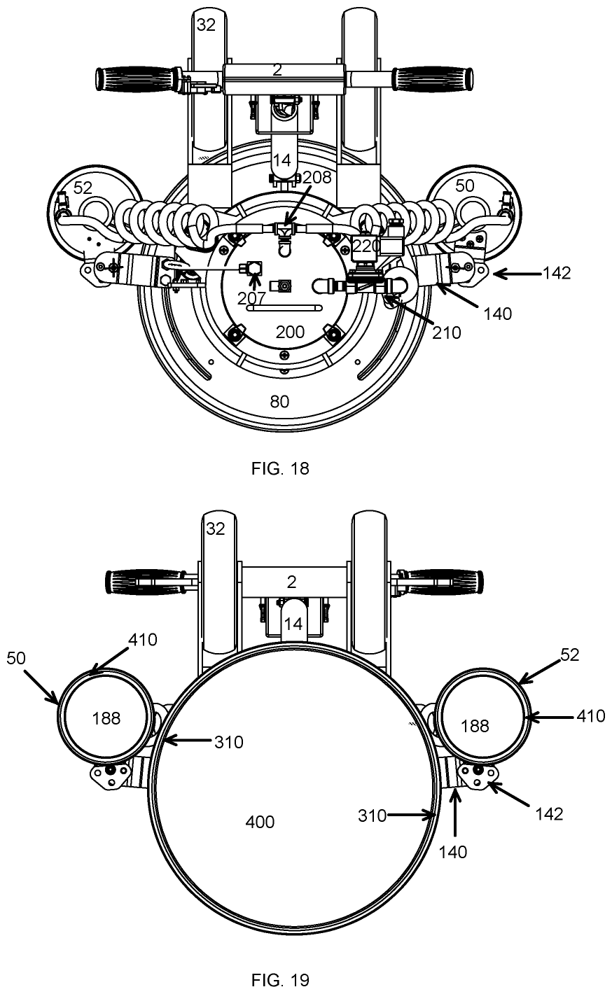

FIG. 18 depicts a top view of the device, and a bottom view of the device is depicted in FIG. 19. Wheels 32, control panel 2, upright handle 14, small left and right mounting disks 50/52, motor mounting bracket 140 and small disk mounting bracket 142 are shown in both figures. Lid 200, pressure release valve 207, female “T” 208, powered solenoid valve 220, and 90° elbow 210 are shown in FIG. 18. Small stain pads 188, large stain pad 400, small stain pad channel 410, and large stain pad channel 310 are shown in FIG. 19.

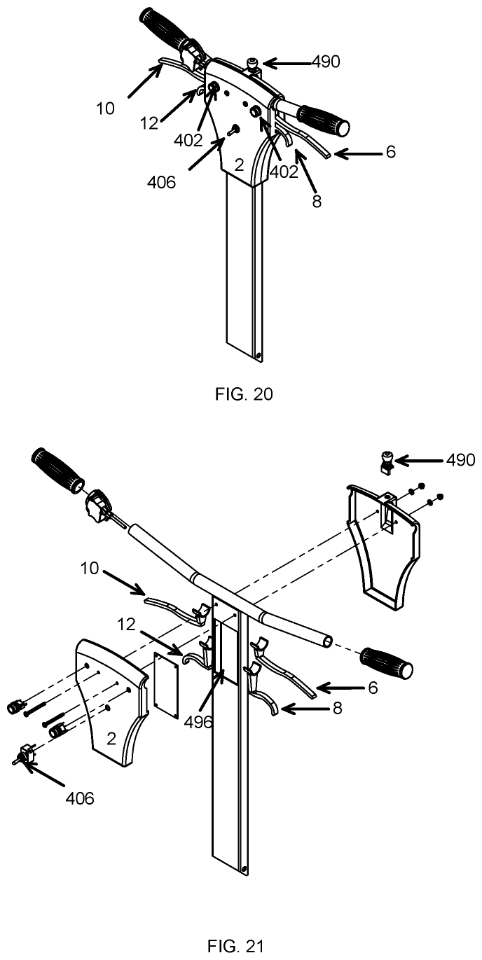

FIG. 20 illustrates a front, angled view of the handle assembly and FIG. 21 depicts an exploded view of the handle assembly. Handle release button 490 may be pulled in an up motion to release tension control bracket 16 releasing tension on upright handle 14 allowing upright handle 14 to pivot relative to large mounting disk 80. One small disk on/off switch 402 is paired to small left mounting disk 50, and a separate small disk on/off switch 402 is paired to small right mounting disk 52. Lever 6 may allow a user to control the amount of stain released onto the large stain disk. Lever 10 may allow a user to control the rate of spin of the large stain disk, which is mounted onto large mounting disk 80. Lever 8 may allow a user to control the rate of spin of small left mounting disk 50 and the amount of stain released onto the small left stain disk. Lever 12 may control the rate of spin of small right mounting disk 52 and the amount of stain released onto the small right stain disk. Air compressor on/off switch 406 is centered on control panel 2. Handle wiring opening 496 allows wires from the control handles and levers to be run through upright handle 14.

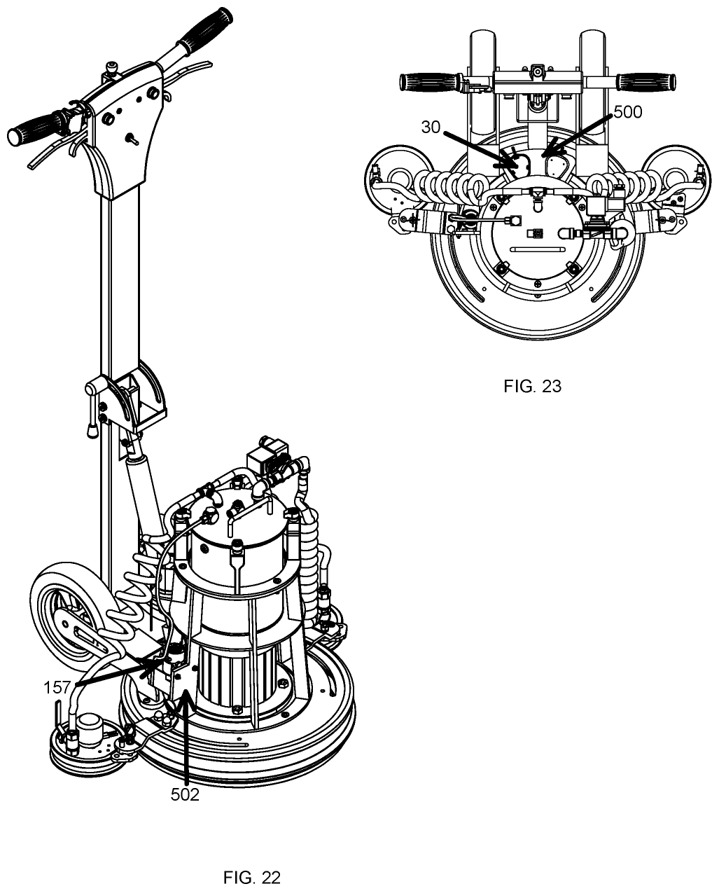

An optional embodiment wherein air pump 157 is positioned within air pump mount 502 is shown in FIG. 22. FIG. 23 illustrates an optional embodiment wherein the device utilizes two batteries 30 for power. Each battery 30 is positioned within multiple battery mount 500.

I hereby claim:

1) A cordless upright floor staining device comprising:
an upright handle connecting a gripping means to a motor, wherein the gripping means may be gripped by a user, wherein the motor provides a rotary motion to a staining pad, wherein the staining pad applies a stain to a floor,
at least one battery that provides power to operate the motor,
a means for holding a quart or gallon container of the stain, and
a means that transfers the stain from the container to the staining pad.

2) The device of claim 1 further comprising:
two smaller staining pads that are coupled to the upright handle, wherein the two smaller staining pads receive stain from the container of stain, wherein each of the two smaller staining pads is coupled to an accessory motor that provides rotary motion to the two smaller staining pads, wherein the two smaller staining pads apply stain to the floor, wherein each of the two smaller staining pads is able to move relative to each other and relative to the staining pad.

3) The device of claim 1 further comprising a motor control means that controls the rotary motion provided by the motor.

4) The device of claim 2 further comprising an accessory motor control means that controls the rotary motion provided by the accessory motor.

5) The device of claim 2 further comprising two cam rollers, wherein the two smaller staining pads are able to move relative to each other and relative to the staining pad by moving along the two cam rollers, wherein the two cam rollers are positioned on a bottom side of a motor mounting disk, and wherein the motor is mounted on a top side of the motor mounting disk.

6) The device of claim 1 wherein movement of stain is controlled by a powered solenoid valve from the quart or gallon container to the staining pad.

7) The device of claim 6 wherein the a manifold that directs and distributes an airflow to the powered solenoid valve.

8) The device of claim 1 further comprising an air pump that pumps air into the quart or gallon container of stain while the stain is being transferred to the staining pad.

9) The device of claim 1 further comprising:
two smaller staining pads that are coupled to the upright handle, wherein the two smaller staining pads receive stain from the container of stain, wherein each of the two smaller staining pads is coupled to an accessory motor that provides rotary motion to the two smaller staining pads, wherein the two smaller staining pads apply stain to the floor, wherein each of the two smaller staining pads is able to move relative to each other and relative to the staining pad,
a motor control means that controls the rotary motion provided by the motor,
an accessory motor control means that controls the rotary motion provided by the accessory motor,
two cam rollers, wherein the two smaller staining pads are able to move relative to each other and relative to the staining pad by moving along the two cam rollers, wherein the two cam rollers are positioned on a bottom side of a motor mounting disk, and wherein the motor is mounted on a top side of the motor mounting disk,
a powered solenoid valve that controls the movement of the stain from the quart or gallon container to the staining pad, wherein the a manifold that directs and distributes an airflow to the powered solenoid valve, and
an air pump that pumps air into the quart or gallon container of stain while the stain is being transferred to the staining pad.

10) A round pad for applying stain to a floor wherein the round pad has a circular channel running a perimeter of the round pad, wherein the circular channel applies a flow of stain to a floor being stained, wherein the round pad is composed of a carpet textile, such as polypropylene, nylon, polyester wool, cotton, cotton terry, or acrylic.
